(19) United States
(12) Patent Application Publication
(10) Pub. No.: US 2005/0054491 A1
(43) Pub. Date: Mar. 10, 2005

(54) Massage seat cushion

(76) Inventors: Hsin-Yi Lin, Chia-I Hsien (TW); Yuan-Feng Chang, Chia-I Hsien (TW)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/657,217

(22) Filed: Sep. 9, 2003

(51) Int. Cl. A61H 1/00

(52) U.S. Cl. 482/57; 482/56

(57) ABSTRACT

A seat cushion includes a cushion body and a vibrating unit. The cushion body has a rear section adapted to press against the buttocks of a user, and a front section including two spaced-apart thigh support portions, and a protruding portion projecting upwardly between the thigh support portions and adapted to press against the groin portion of the user. The vibrating unit is disposed in the protruding portion for massaging the groin portion of the user so as to promote blood circulation.

### BACKGROUND OF THE INVENTION

1. Field of the Invention

The invention relates to a seat cushion, more particularly to a seat cushion that is designed according to the contour of a human body and that has a vibrating unit for massaging the groin portion of a human body.

2. Description of the Related Art

Generally, a seat cushion is used to provide comfort for the user when seated on an office chair or a vehicle seat. However, such effect is limited since the thighs and the buttocks of the user are likely to suffer a definite degree of pressure attributed to long term sitting on the conventional seat cushion, which in turn can affect blood circulation in the user's body.

### SUMMARY OF THE INVENTION

Therefore, the object of the present invention is to provide a seat cushion that is capable of massaging the groin portion of a human body so as to promote blood circulation of the blood vessels near the groin portion so that irregular blood circulation can be reduced and so as to promote good health.

According to this invention, a seat cushion comprises a cushion body and a vibrating unit. The cushion body has a rear section adapted to press against the buttocks of a user, and a front section extending frontwardly from the rear section. The front section includes two spaced-apart thigh support portions, and a protruding portion projecting upwardly between the thigh support portions and adapted to press against the groin portion of the user. The vibrating unit is disposed in the protruding portion for massaging the groin portion of the user so as to promote blood circulation.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a seat cushion according to the present invention;

FIG. 2 illustrates the seat cushion of the present invention in a state of use;

FIG. 3 is a schematic view of the preferred embodiment; and

FIG. 4 is an enlarged fragmentary schematic view of FIG. 2, illustrating positions of a vibrating unit, a first heating unit, and a second heating unit of the preferred embodiment.

### DETAILED DESCRIPTION OF THE PREFERRED EMBODIMENT

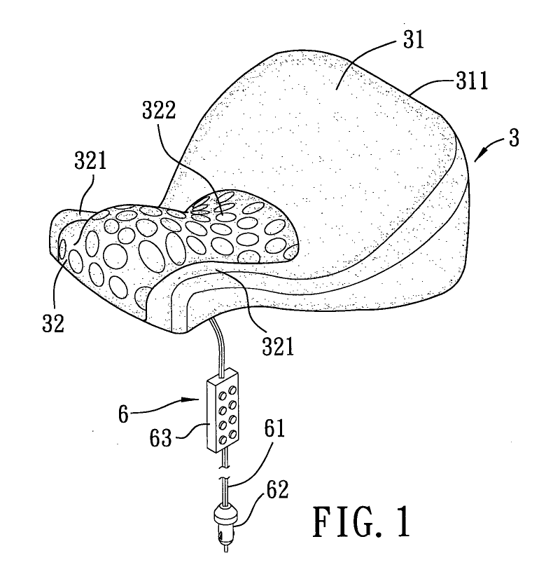

Referring to FIGS. 1 to 4, the preferred embodiment of a seat cushion according to the present invention is shown to comprise a cushion body 3, a vibrating unit 4, a first heating unit 51, a second heating unit 52, and a controlling unit 6.

The cushion body 3 is designed ergonomically, and is made of a foam material. The cushion body 3 has a rear section 31 adapted to press against the buttocks 21 of a user 2, and a front section 32 extending frontwardly from the rear section 31. The rear section 31 is enlarged rearwardly and outwardly from the front section 32, and has a height that increases upwardly and rearwardly from the front section 32. The front section 32 includes two spaced-apart thigh support portions 321 for supporting two thighs 22 of the user 2, and a protruding portion 322 projecting upwardly between the thigh support portions 321 and adapted to press against the groin portion of the user 2.

An outer surface of the protruding portion 322 may be designed with uneven concave and convex patterns to provide the seat cushion of the present invention with a better air circulation effect. To manufacture the cushion body 3, the protruding portion 322 of the front section 32 and the other portions of the cushion body 3 may be made of foam materials with different densities according to the different supporting forces required by different portions of the cushion body 3.

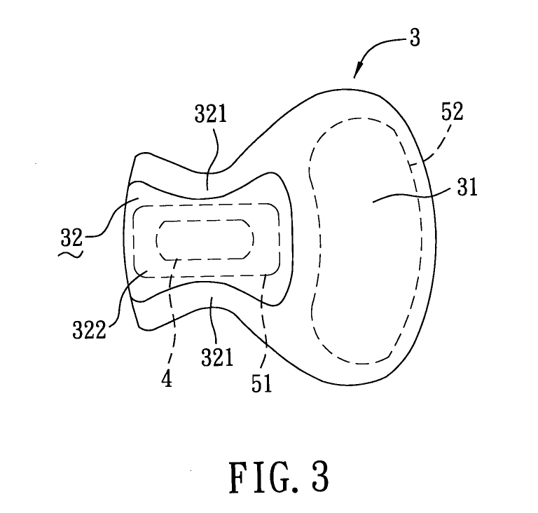

The vibrating unit 4 (see FIG. 3) is disposed inside the protruding portion 322 of the cushion body 3. In this embodiment, the vibrating unit 4 is an electrically operated vibrating device. Since the structure of the vibrating device is known in the art and is not pertinent to the present invention, a detailed description of the same will be dispensed with herein for the sake of brevity. Since the vibrating unit 4 is disposed inside the protruding portion 322, and since the protruding portion 322 faces the groin portion of the user 2, the groin portion between the two thighs 22 of the user 2 is massaged to promote blood circulation.

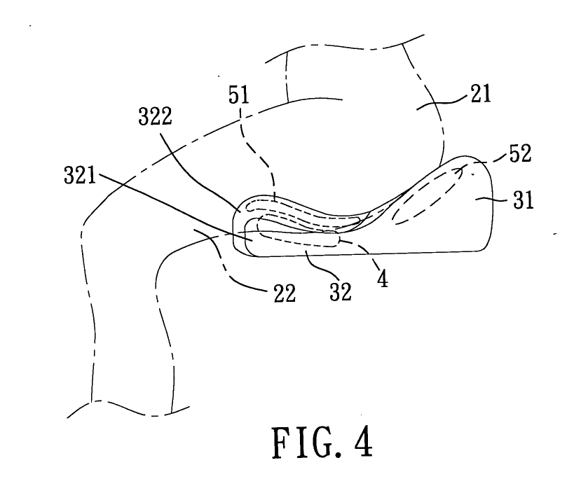

The first heating unit 51 (see FIGS. 3 and 4) is disposed inside the protruding portion 322 of the cushion body 3 and above the vibrating unit 4, and is located adjacent to the outer surface of the protruding portion 322. In this embodiment, the first heating unit 51 is an electric heating device. The heat generated during operation of the first heating unit 51 penetrates from the outer surface of the protruding portion 322 into the groin portion of the user 2, thereby further promoting the blood circulation at the blood vessels of the groin portion of the user 2.

The second heating unit 52 (see FIGS. 3 and 4) is disposed inside and is located adjacent to an outer surface of the rear section 31 of the cushion body 3. In this embodiment, the second heating unit 52 is also a known electric heating device. The heat generated during operation of the second heating unit 52 penetrates from the outer surface of the rear section 31 into the buttocks 21 of the user 2, thereby promoting the blood circulation at the blood vessels of the buttocks 21.

Since the structure of each of the first and second heating units 51, 52 is not pertinent to the present invention, and since many structural designs of the heating devices are available in the market that can be used in the seat cushion of this invention, a detailed description of the same will be dispensed with herein for the sake of brevity.

The design of the seat cushion of the present invention does not necessarily include both the first and second heating units 51, 52 in the cushion body 3. In practice, the cushion body 3 may be provided with only the first or the second heating unit 51, 52 depending on actual requirements.

The controlling unit 6 (see FIG. 1) includes an electric cable 61 extending outwardly from the cushion body 3, a control member 63 connected to the cable 61, and an electrical plug 62 connected fixedly to one end of the cable 61 for connection with a complementary socket (not shown). The controlling unit 6 is connected electrically to the vibrating unit 4 and the first and second heating units 51, 52, and is used to control activation of the vibrating time and the vibrating strength of the vibrating unit 4, and the heating time and the temperature of the first and second heating units 51, 52, etc.

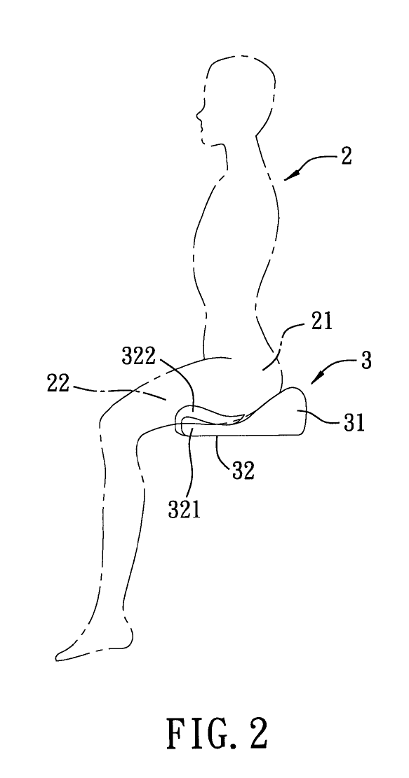

Referring back to FIGS. 2 and 4, when the user 2 sits on the seat cushion of the present invention, the thighs 22 press against the thigh support portions 321 of the front section 32 and are supported by the same, while the buttocks 21 press against the rear section 31 and are supported by the same. At this time, the user 2 can activate the vibrating unit 4 through the controlling unit 6 so as to proceed with a vibrating massage on the groin portion of the user 2. As such, the seat cushion of the present invention not only can comfortably support the weight of the user 2, but can also effect massaging function on the groin portion of the user 2 simultaneously. At the same time, the first and second heating units 51, 52 can be activated optionally so as to heat respectively the groin portion and the buttocks 21 of the user 2, thereby promoting blood circulation thereat so that discomfort due to long periods of sitting can be minimized, and so as to promote good health.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A seat cushion comprising:
a cushion body having a rear section adapted to press against the buttocks of a user, and a front section extending frontwardly from said rear section, said front section including two spaced-apart thigh support portions, and a protruding portion projecting upwardly between said thigh support portions and adapted to press against the groin portion of the user; and
a vibrating unit disposed in said protruding portion for massaging the groin portion of the user so as to promote blood circulation.

2. The seat cushion as claimed in claim 1, further comprising a first heating unit disposed inside said protruding portion and operable so as to provide heat for further promoting blood circulation.

3. The seat cushion as claimed in claim 1, further comprising a second heating unit disposed inside said rear section and operable so as to provide heat for further promoting blood circulation.

4. The seat cushion as claimed in claim 1, further comprising a controlling unit connected electrically to said vibrating unit for controlling activation of said vibrating unit.

5. The seat cushion as claimed in claim 1, wherein said protruding portion of said front section has an outer surface provided with concave and convex patterns so as to effect air circulation.

6. The seat cushion as claimed in claim 1, wherein said rear section is enlarged rearwardly and outwardly from said front section, and has a height that increases upwardly and rearwardly from said front section.
